(19) United States
(12) Patent Application Publication
(10) Pub. No.: US 2017/0065893 A1
(43) Pub. Date: Mar. 9, 2017

(54) ELECTRONIC PROCESSING SYSTEM WITH VERIFIED ACCOUNTS AND METHOD OF OPERATION THEREOF

(71) Applicant: SONY INTERACTIVE ENTERTAINMENT NETWORK AMERICA LLC, San Mateo, CA (US)

(72) Inventors: Shunsuke Kunieda, San Francisco, CA (US); Wivat Kruawongwanich, Concord, CA (US); Michelle Downes, San Francisco, CA (US); Ping Li, San Francisco, CA (US); Naoki Kamimaeda, Saitama (JP); Christopher Thielbar, Tokyo (JP); Masayuki Ebisawa, Foster City, CA (US)

(21) Appl. No.: 15/254,909

(22) Filed: Sep. 1, 2016

Related U.S. Application Data
(60) Provisional application No. 62/214,493, filed on Sep. 4, 2015.

(51) Int. Cl. A63F 13/79; H04L 12/58; H04L 29/08; A63F 13/35; G06F 3/0484; A63F 13/25; A63F 13/335; G06F 17/30; G06F 3/0481

(52) U.S. Cl. CPC A63F 13/79; G06F 17/30657; H04L 51/32; H04L 67/306; G06F 3/04817; G06F 3/0484; A63F 13/25; A63F 13/335; A63F 13/35

(57) ABSTRACT

An electronic processing system, and a method of operation thereof, including: a verification module for connecting to a gaming network using a user account and for associating a verified account with the user account by performing a single click operation on a following button to follow the verified account; a recommendation module, coupled to the verification module, for receiving a comment about the verified account in a comment entry control; and a display module, coupled to the recommendation module, for displaying the comment in a comments list display.

### CROSS-REFERENCE TO RELATED APPLICATION(S)

This application claims the benefit of U.S. Provisional Patent Application Ser. No. 62/214,493 filed Sep. 4, 2015, and the subject matter thereof is incorporated herein by reference thereto.

### TECHNICAL FIELD

The present invention relates generally to an electronic processing system and more particularly to a system for electronic processing with verified accounts.

### BACKGROUND ART

Social networking is a practice of expanding a number of one's business and/or social contacts by making connections through individuals. While social networking has gone on almost as long as societies have existed, an unparalleled potential of the Web to facilitate such connections has been recognized and exploited, through Web-based groups established for that purpose.

The world of the Internet is changing rapidly. Social networking allows users to become increasingly comfortable with making a significant percentage of their purchases online. Over the past years, there has been a remarkable transformation in the kind of content available online. Video in both short form and long form is now readily available through multiple portals and platforms. However, electronic processing systems that support the social networking are currently still encountering problems due to lack of innovative solutions that effectively deliver quality of contents to target audiences.

Thus, a need still remains for an electronic processing system that delivers innovation and technological advances to enable the users to effectively share and efficiently distribute proper contents within social networks. In view of the increasing demand for such electronic processing systems, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

Embodiments of the present invention provide a method of operation of an electronic processing system including: connecting to a gaming network using a user account; associating a verified account with the user account by performing a single click operation on a following button to follow the verified account; receiving a comment about the verified account in a comment entry control; and displaying the comment in a comments list display.

The embodiments of the present invention provide an electronic processing system, including: a verification module for connecting to a gaming network using a user account and for associating a verified account with the user account by performing a single click operation on a following button to follow the verified account; a recommendation module, coupled to the verification module, for receiving a comment about the verified account in a comment entry control; and a display module, coupled to the recommendation module, for displaying the comment in a comments list display.

Certain embodiments of the invention have other steps or elements in addition to or in place of those mentioned above. The steps or the elements will become apparent to those skilled in the art from a reading of the following detailed description when taken with reference to the accompanying drawings.

### BRIEF DESCRIPTION OF THE DRAWINGS

FIG. 1 is a system block diagram of an electronic processing system with a social network mechanism in an embodiment of the present invention.

FIG. 2 is an element block diagram.

FIG. 3 is an example of the verified accounts.

FIG. 4 is an example of a custom activity tool.

FIG. 5 is an example of a tile view.

FIG. 6 is an example of the gallery view.

FIG. 7 is an example of a friends application screen.

FIG. 8 is an example of a profile screen.

FIG. 9 is an example of a whats new information tile.

FIG. 10 is an example of a recommended verified accounts screen.

FIG. 11 is an example of a single grid view screen.

FIG. 12 is an example of a multiple grid view screen.

FIG. 13 is an example of a gallery following view.

FIG. 14 is an exemplary process flow of a follow verified accounts process.

FIG. 15 is a flow chart of a method of operation of an electronic processing system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the embodiments of the present invention.

In the following description, numerous specific details are given to provide a thorough understanding of the invention. However, it will be apparent that the invention may be practiced without these specific details. In order to avoid obscuring the embodiments of the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs.

Where multiple embodiments are disclosed and described having some features in common, for clarity and ease of illustration, description, and comprehension thereof, similar and like features one to another will ordinarily be described with similar reference numerals. The embodiments have been numbered first embodiment, second embodiment, etc. as a matter of descriptive convenience and are not intended to have any other significance or provide limitations for the embodiments of the present invention.

The term “module” referred to herein can include software, hardware, or a combination thereof in the embodiments of the present invention in accordance with the context in which the term is used. For example, the software can be machine code, firmware, embedded code, and application software. Also for example, the hardware can be circuitry, processor, computer, integrated circuit, integrated circuit cores, a microelectromechanical system (MEMS), passive devices, environmental sensors including temperature sensors, or a combination thereof.

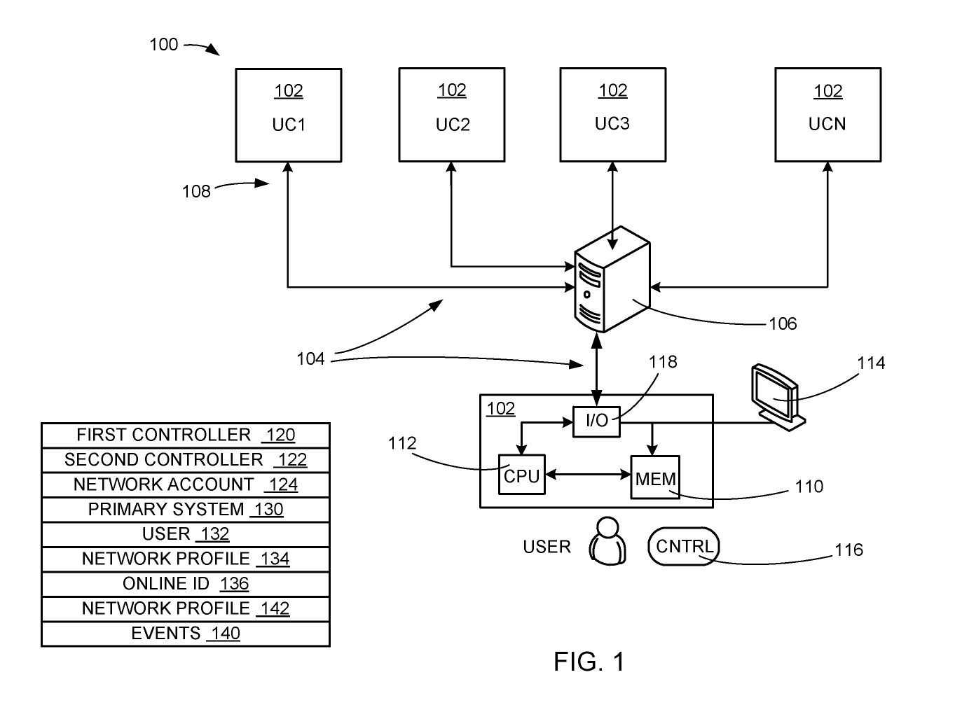

Referring now to FIG. 1, therein is shown a system block diagram of an electronic processing system 100 with a social network mechanism in an embodiment of the present invention. The system block diagram shows a plurality of game consoles 102 utilized by users in a gaming network 104.

The game consoles 102 are devices that process information including video signals and visual images for video games. For example, the game consoles 102 can include PlayStation 4 (PS4) and any other video game consoles. Also for example, the game consoles 102 can include tablets, PlayStation Vita, handheld game consoles, or any other portable gaming devices.

The gaming network 104 provides interconnections of platforms, systems, and applications for exchanging information. In the gaming network 104, networked computing devices exchange data with each other using a data link between nodes that are established using either cable media or wireless media. For example, the gaming network 104 can include a PlayStation Network (PSN) and any other gaming networks.

The users can engage in game plays or other activities. Information relating to such activities can be sent to a number of servers 106. The servers 106 are devices that manage access to a centralized resource or service in a network. The gaming network 104 includes a number of user connections 108 between the game consoles 102 and the servers 106. The user connections 108 are the interconnections that provide communications mechanisms for exchanging information among the platforms, the systems, and the applications.

The electronic processing system 100 can include one or more of the servers 106 used for obtaining information relating to the activities of the users from the game consoles 102. The information relating to the activities of the user connections 108 is transmitted to a storage device 110 in each of the game consoles 102 for later presentation on a display.

For example, the activities can include game plays or any other actions or events of the users associated with the video games. Also for example, the storage device 110 can include volatile and nonvolatile memory devices.

The users can see all comments posted by the user connections 108. The comments and game shares including screen shots can be handled by a processor 112 of each of the game consoles 102. For example, the processor 112 can include a central processing unit (CPU) or any other computing devices.

Display devices 114 can be separate from the game consoles 102 or integrated within the game consoles 102. The display devices 114 output the video signals or the visual images for the video games.

Controllers 116 are devices that the users utilize with game or entertainment systems to manipulate or control the game consoles 102. The controllers 116 provide input to the video games to control objects or characters in the video games. The controllers 116 can be separate from the game consoles 102 or integrated within the game consoles 102. For example, the controllers 116 can include G-Shock controllers or any other control devices.

For gaming applications, the controllers 116 can include a first controller 120 and a second controller 122, one for each player. The electronic processing system 100 can be connected to the first controller 120 and the second controller 122 simultaneously. Alternatively, the second controller 122 can be connected to another of the electronic processing system 100.

Each of the game consoles 102 includes an input/output unit 118 (I/O) for providing input and output functions or data transmission. The input/output unit 118 provides the data transmission between the game consoles 102 and the servers 106, the display devices 114, and the controllers 116.

The electronic processing system 100 can be associated with a network account 124. The network account 124 is a unique identifier across the gaming network 104. The network account 124 can be activated and associated with a primary system 130. For example, the network account 124 can be a PlayStation Network account (PSN).

The primary system 130 can be the electronic processing system 100 of a user 132. The primary system 130 can be deactivated by transferring the network account 124 away from the primary system 130. The primary system 130 can only be deactivated at the electronic processing system 100 where it was activated.

The network account 124 can include a network profile 134. The network profile 134 includes information about the network account 124.

The network account 124 can be linked to an online id 136. The online id 136 is a unique identifier for the user. The online id 136 can be used to access the gaming network 104 via the network account 124.

The network account 124 can be used to form a network connection 142. The network connection 142 is a digital communication link between the electronic processing system 100 and the gaming network 104.

The electronic processing system 100 is linked to the gaming network 104 to facilitate gaming and other types of social interaction. The user 132 can access the electronic processing system 100 having the controllers 116 and connect to the gaming network 104. The user 132 can participate in events 140 controlled through the gaming network 104. For example, the events 140 can include games, tournaments, matches, competitions, accessing media and other content, or a combination thereof. The events 140 can be shared experiences with other users.

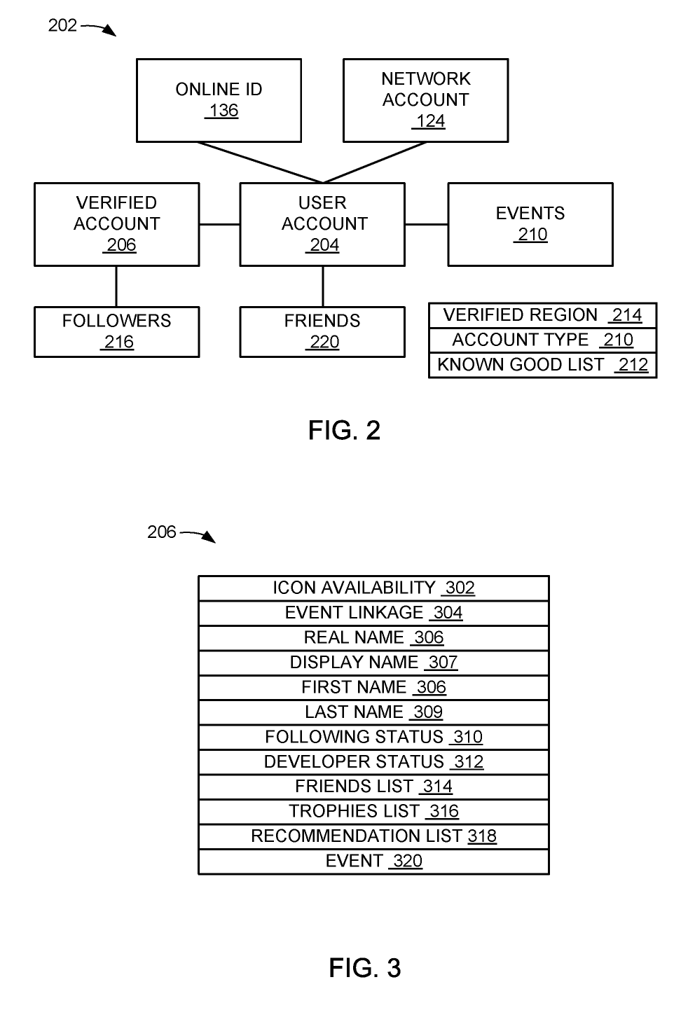

Referring now to FIG. 2, therein is shown an element block diagram 202. Each of the elements can interact with other elements within the gaming network 104 of FIG. 1.

The user 132 of FIG. 1 can have a user account 204 as a primary identifier. The user account 204 can be used to access the electronic processing system 100 of FIG. 1.

The user account 204 can be associated with the online id 136 of FIG. 1. The online id 136 is an identifier used to display information about the user account 204 on the gaming network 104.

The user account 204 can be associated with the network account 124 of FIG. 1. The network account 124 is an identifier to provide access to the gaming network 104. The network account 124 can be associated with the online id 136.

The user account 204 can be identified as verified accounts 206. The verified accounts 206 are an account type 210 of FIG. 2 that indicates that the user account 204 is linked to a known entity. The known entity can be a gaming company, a person, a game franchise, a professional gamer, media content, executives, or a combination thereof.

The verified accounts 206 are pre-authorized designators that show that the user account 204 is related to the known entity. The operator of the gaming network can allow the known entities to register to create the verified accounts 206.

The verified accounts 206 can be stored in a known good list 212 of the verified account 206. The verified accounts 206 can be associated with the user account 204. The known good list 212 is a list of entities that are pre-vetted by the operator of the gaming network and are allowed to be designated as the verified accounts 206.

The verified account 206 can be associated with a verified region 214. The verified region 214 is a locale associated with the verified accounts 206. The locale can be a geographical location, a virtual location, a named location, or a combination thereof.

The verified accounts 206 can have followers 216. The followers 216 can include the user account 204 of other people that are associated with one or more of the verified accounts 206. The user account 204 can be associated with the verified accounts 206 by following one or more of the verified accounts 206. The followers 216 are users who are interested in one of the verified accounts 206.

It has been discovered that using the verified accounts 206 increases the reliability of the gaming network 104 by providing a guaranteed link to the user account 204 for the known entity. The verified accounts 206 provide a way to provide access to official content, media, games, events, and other network content.

The user account 204 can be associated with events 140 of FIG. 1. The events 140 can be games, tournaments, matches, media events, concerts, or a combination thereof. For example, the user account 204 can be associated with a gaming tournament by registering the user account 204 to play in the tournament. The events 140 can be public or private. Some of the events 140 can be associated with one or more of the verified accounts 206 and only visible to the user account 204 if the user account 204 is associated with one of the verified accounts 206.

The user account 204 can have friends 220. The friends 220 are other users who have a relationship with the user account 204. The friends 220 can form an ad hoc community. The friends 220 can be linked to the user account 204 be sending and accepting a friends request.

Referring now to FIG. 3, therein is shown an example of the verified accounts 206. Each of the verified accounts 206 can be linked to the user account 204 of FIG. 2 that has been confirmed to belong to the users.

The verified accounts 206 can be represented using a data structure having the properties associated with the verified accounts 206. The verified accounts 206 can represent a person, company, game, program, or a combination thereof. For example, one of the verified accounts 206 can represent a known company such as Sony.

The verified accounts 206 can be linked to the user account 204. The verified accounts 206 can also be associated with the online id 136 of FIG. 1 and the network account 124 of FIG. 1.

The network account 124 can be associated with the network profile 134 of FIG. 1. The network profile 134 contains information describing the user account 204 and the gaming network 104 of FIG. 1.

The verified accounts 206 can have a variety of properties. For example, the verified accounts 206 can include the user account 204, the account type 210 of FIG. 2, an icon availability 302, an event linkage 304, a real name 306, a display name 307, a following status 310, or similar properties.

The user account 204 is a value to identify a user. The user account 204 can be implemented as a number, an alphanumeric value, a hierarchical value, or a combination thereof.

The account type 210 is a value to indicate the type of account. For example, the account type 210 can indicate that the user account 204 is used for a person, a company, an organization, a game, a band, a group, or a combination thereof.

The icon availability 302 is a flag to indicate that the user account 204 can use an icon to signify that the user account 204 has the status of being verified. For example, the icon availability 302 can be used to determine if the icon can be displayed when presenting a verified icon 324 for one of the verified accounts 206. The verified icon 324 is a graphic or symbol, or image used to indicate the verified accounts 206. Only the verified accounts 206 are permitted to display the verified icon 324.

The event linkage 304 is an identifier designating an event 320. The event linkage 304 can connect one of the verified accounts 206 to the event 320. The event linkage 304 can allow the verified accounts 206 to share a private set of events with followers.

The real name 306 is the designator for the name of the user associated with the user account 204. The real name 306 can have a first name 308 and a last name 309.

The display name 307 is an identifier associated with the user account 204. The display name 307 can be a single alphanumeric value. The display name 307 can only be associated with one of the verified accounts 206. Only the user for the verified accounts 206 can override the real name 306 with the display name 307.

Each of the verified accounts 206 can be assigned the display name 307 to allow more flexibility when providing the name to display to users. Within the gaming network 104, only one of the verified accounts 206 can override the display of the real name 306 which requires the first name 308 and the last name 309 to be provided. The display name 307 can be one or more words. The display name 307 can be limited to 32 characters.

For example, the real name 306 for a company could be “Sony Corporation”. If the Sony Corporation” is one of the verified accounts 206, then the display name 307 can be set to “Sony” instead of “Sony Corporation”.

It has been discovered that providing the display name 307 allowing a single word improves user recognition and branding retention. By providing the display name 307 and the real name 306 for the verified accounts 206, the effectiveness of the messages related to the verified accounts 206 is improved.

The following status 310 is a value to indicate that one of the verified accounts 206 can be followed. The following status 310 can be a number, an alphanumeric value, or a combination thereof. The following status 310 can also be a value to identify one of the verified accounts 206.

A developer status 312 is a value to indicate that the user account 204 is a developer and can access resources that are limited to developers. The developer status 312 can be a number, an alphanumeric value, or a combination thereof.

The verified accounts 206 can be associated with a friends list 314. The friends list 314 can be a list of other users who are friends with the user account 204.

The verified accounts 206 can be associated with a trophies list 316. The trophies list 316 can be a list of trophies and other accomplishments associated with the user account 204.

The verified accounts 206 can be associated with a recommendation list 318. The recommendation list 318 can be a list of other verified accounts 206 that can be linked or associated the first one of the verified accounts 206.

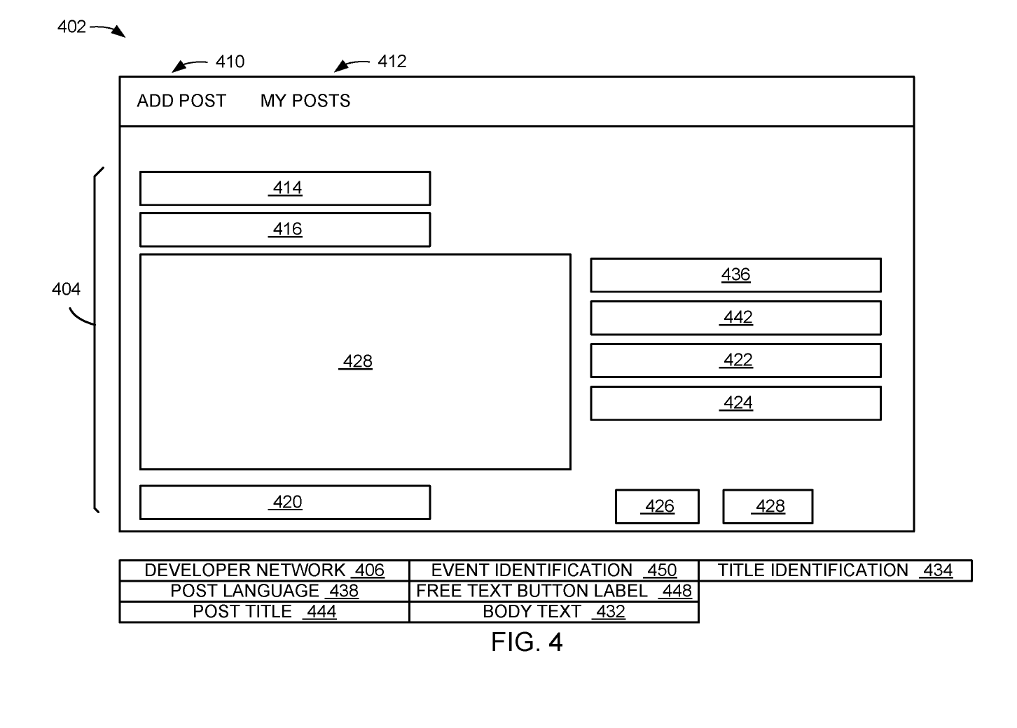

Referring now to FIG. 4, therein is shown an example of a custom activity tool 402. The custom activity tool 402 can create customized posts 404 in order to accommodate the functions of the verified accounts 206 of FIG. 2.

The custom activity tool 402 is a user screen for interacting with users. The custom activity tool 402 can be accessed via the electronic processing system 100 of FIG. 1.

The custom activity tool 402 can perform a variety of functions. The custom activity tool 402 can create customized posts 404, preview activity before it is officially posted to followers, manage previous posts, delete posts, and other similar functions. The custom activity tool 402 can be accessed by the electronic processing system 100.

The custom activity tool 402 is a tool for users who need to manage the verified accounts 206. The custom activity tool 402 can ensure that verified account holder have a consistent experience when managing their own accounts.

The custom activity tool 402 can be accessed from a developer network 406, such as DevNet. The developer network 406 is a private network with controlled access and limited to developers. Access to the developer network 406 can be limited to the user account 204 of FIG. 2 having the developer status 312 of FIG. 3 enabled. The private network can include network traffic that is carried over the Internet.

The customized posts 404 can be created using an add post screen 408. The add post screen 408 can include a add post menu item 410, a my posts menu item 412, and other similar commands.

The add post menu item 410 call allow the user to create one of the customized posts 404. The add post menu item 410 can save the text of the customized posts entered in the text box. The my posts menu item 412 can allow the users to display a list of posts and comments they have created.

The add post screen 408 can include a language selector 414, a post title control 416, a file upload control 418, a body text control 420, a title identification control 422, an event identification control 436, custom web link buttons 426, or similar controls.

The language selector 414 allows the selection of a post language 438 for one of the customized posts 404. The language selector 414 can be a drop down text selector, a rotary text control, a text box, or a combination thereof.

The post title control 416 allows the entry of a post title 444 for one of the customized posts 404. The post title control 416 can be a text box or similar control.

The file upload control 418 allows the selection and unloading of a media file 428. The file upload control 418 can be a file selector control, a drag-and-drop control, or a combination thereof.

The media file 428 can have a variety of configurations. The media file 428 can include images of various sizes; 640×480, 956×956, or other sizes. The media file 428 can be a video file. The media file 428 can be transcoded on the server side. For example, the media file 428 can be transcoded into a different format on the PlayStation network.

The body text control 420 allows the entry of body text 432 for one of the customized posts 404. The body text control 420 can be a text box or a similar control.

The body text 432 is descriptive text for one of the customized posts 404. The body text 432 can have a variety of configurations. For example, the body text 432 can have a length of up to 1000 characters.

The title identification control 422 can allow the selection of a title identification 434. The title identification control 422 can be a text box or similar control.

The event identification control 436 can allow the selection of an event identification 450. The event identification control 436 can be a text box or similar control. The event identification control 436 can set a link to one of the events 140 of FIG. 1. The event identification 450 is an identifier to uniquely describe the event 320 of FIG. 3.

The custom web link buttons 426 can be configurable controls. The custom web link buttons 426 can include a free text button label 448. The free text button label 448 is a text string for identifying the custom web link buttons 426.

The title identification 434 can include a view in store button 442. The view in store button 442 can include the title identification 434 for display.

It has been discovered that the custom activity tool 402 simplifies the management of customized posts. Providing a centralized tool creates a uniform environment for managing customized posts.

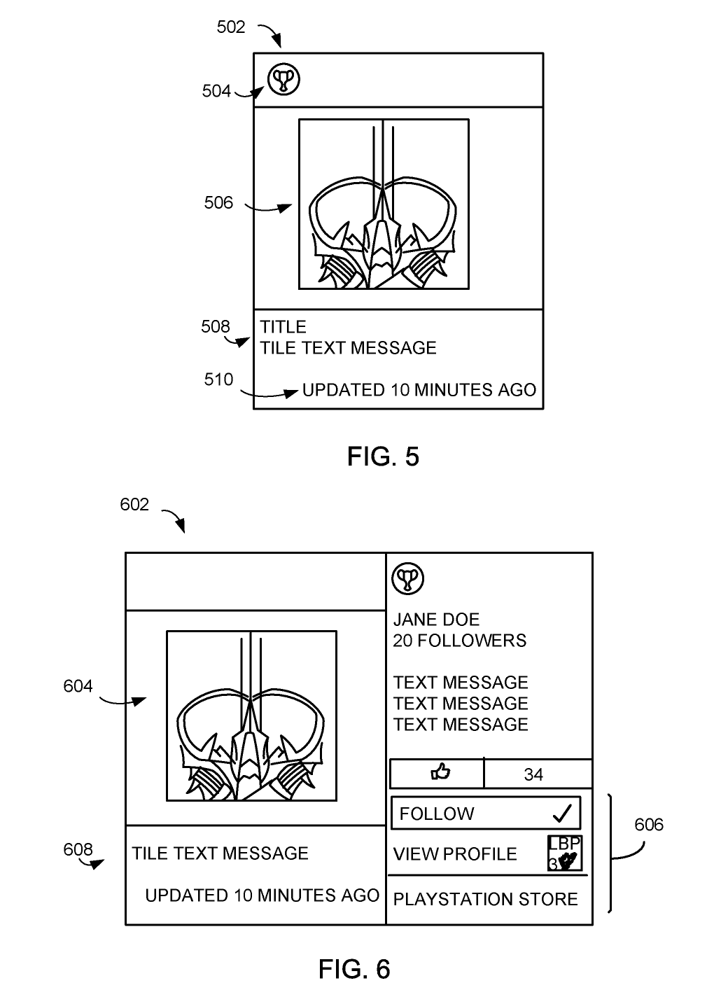

Referring now to FIG. 5, therein is shown an example of a tile view 502. The tile view 502 can present information about one of the verified accounts 206 of FIG. 2.

The tile view 502 is a user screen for interacting with users. The tile view 502 can be accessed via the electronic processing system 100 of FIG. 1.

The tile view 502 can have a variety of configurations. The tile view 502 can include a user identification 504, a verified image 506, a tile text 508, and a tile status 510.

The user identification 504 can provide a link to one of the verified accounts 206. The user identification 504 can include a visual indicator, such as an icon, to identify the user.

The verified image 506 is a context specific image. The verified image 506 can be a logo, image, picture, graphic, or a combination thereof.

The tile text 508 is a text message. The tile text 508 can be a descriptive message about one of the verified accounts 206.

The tile status 510 is a status indicator. For example, the tile status 510 can indicate the time since the last update.

Referring now to FIG. 6, therein is shown an example of the gallery view 602. The gallery view 602 can present information about one of the verified accounts 206 of FIG. 2.

The gallery view 602 is a user screen for interacting with users. The gallery view 602 can be accessed via the electronic processing system 100 of FIG. 1.

The gallery view 602 can have a variety of configurations. The gallery view 602 can include the user identification 504 of FIG. 5, a gallery image 604, a gallery text 608, and gallery controls 606.

The user identification 504 can provide a link to one of the verified accounts 206. The user identification 504 can include a visual indicator, such as an icon, to identify the user.

The gallery image 604 is a context specific image. The gallery image 604 can be a logo, image, picture, graphic, or a combination thereof.

The gallery text 608 is a text message. The gallery text 608 can be a descriptive message about one of the verified accounts 206.

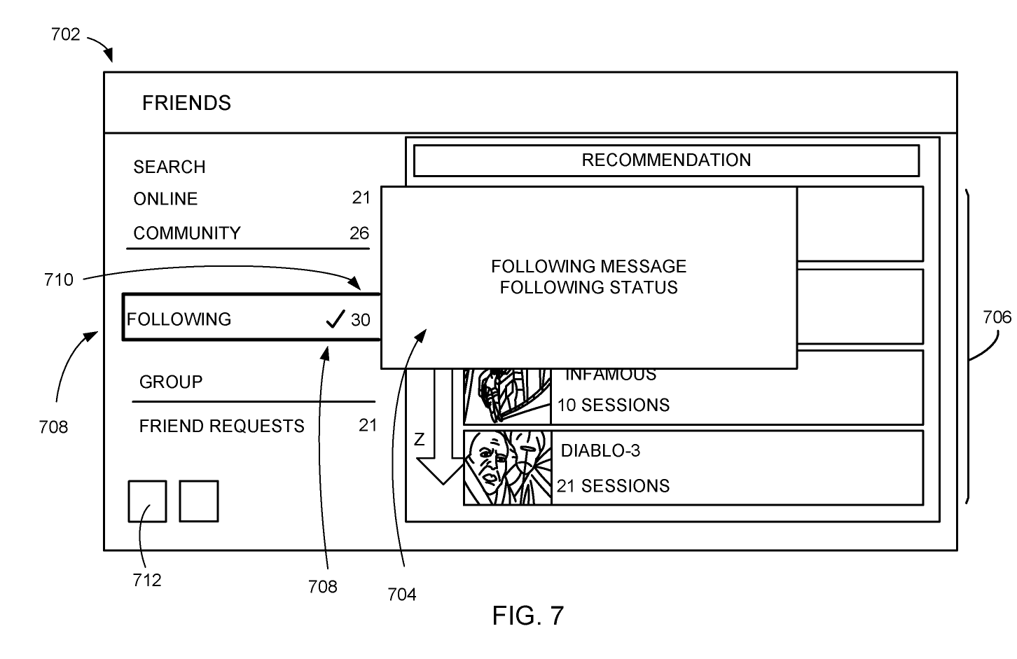

Referring now to FIG. 7, therein is shown an example of a friends application screen 702. The friends application screen 702 can manage the relationship between the verified accounts 206 and the friends who follow the verified accounts 206 of FIG. 2.

The friends application screen 702 is a user screen for interacting with users. The friends application screen 702 can be accessed via the electronic processing system 100 of FIG. 1.

The friends application screen 702 can have a variety of configurations. The friends application screen 702 can include a notification window 704, a following list 706, a following status indicator 708, and an option button. In addition, the friends application screen 702 can include similar command and control buttons such as OK, Cancel, Back, and Enter.

The notification window 704 can display messages about the following status 310. The following status 310 of FIG. 3 provide information for the users who are following one of the verified accounts 206.

The following list 706 can display a list of users and their recommendations or comments about one of the verified accounts 206. The following list 706 can be a floating window with each of the recommendations presented separately. The following list 706 can have a sorting order from A-Z. However, it is understood that the following list 706 can have other sorting orders, such as by date, reverse alphabetical, status, importance, ranking, or other similar sorting orders.

The following status indicator 708 can be an icon or other designator highlighted with a checkmark or other additional symbol to indicate that the following status indicator 708 has been set. The following status indicator 708 shows that the user is following one of the verified accounts 206. The following status indicator 708 can also include a following count 710 to indicate the number of users following one of the verified accounts 206.

An option button 712 is a mode control to access additional and optional functionality. When the option button 712 is selected, the can display a friends list screen.

Additional functionality can be display when the user selects the option button 712. The friends list screen can provide the option to send a message, invite a party to follow the verified account, and compare trophies.

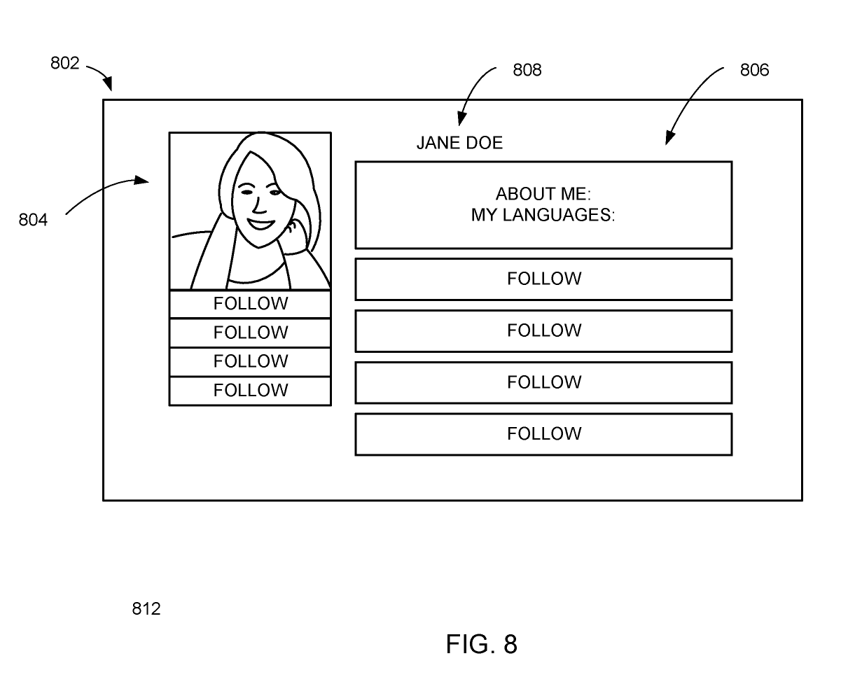

Referring now to FIG. 8, therein is shown an example of a profile screen 802. The profile screen 802 can display information about one the verified accounts 206 of FIG. 2.

The profile screen 802 is a user screen for interacting with users. The profile screen 802 can be accessed via the electronic processing system 100 of FIG. 1.

The profile screen 802 can have a variety of configurations. The profile screen 802 can include a profile image 804, a profile description 806, the recommendation list 318 of FIG. 3, and a profile name 808.

The profile name 808 is an identifier for one of the verified accounts 206. The profile name can be the real name 306 of FIG. 3, the display name 307 of FIG. 3, or a combination thereof.

The profile image 804 is a graphic or picture indicative of one of the verified accounts 206. For example, the profile image 804 can be a graphic of the game franchise represented by one of the verified accounts 206.

The profile description 806 is descriptive text about one of the verified accounts 206. The profile description 806 can provide useful information for users who may decide to follow the account.

The recommendation list 318 is a list of the verified accounts 206 that are recommended by the owner of the profile screen 802. The recommendation list 318 can be a list of the verified accounts 206 that the user like or recommends.

It has been discovered that displaying the recommendation list 318 on the profile screen 802 increases the level of following because the personal recommendation from the profile screen 802 encourages other users to follow one of the verified accounts 206. Distribution of the recommendation list 318 across a user community will improve the follow rate.

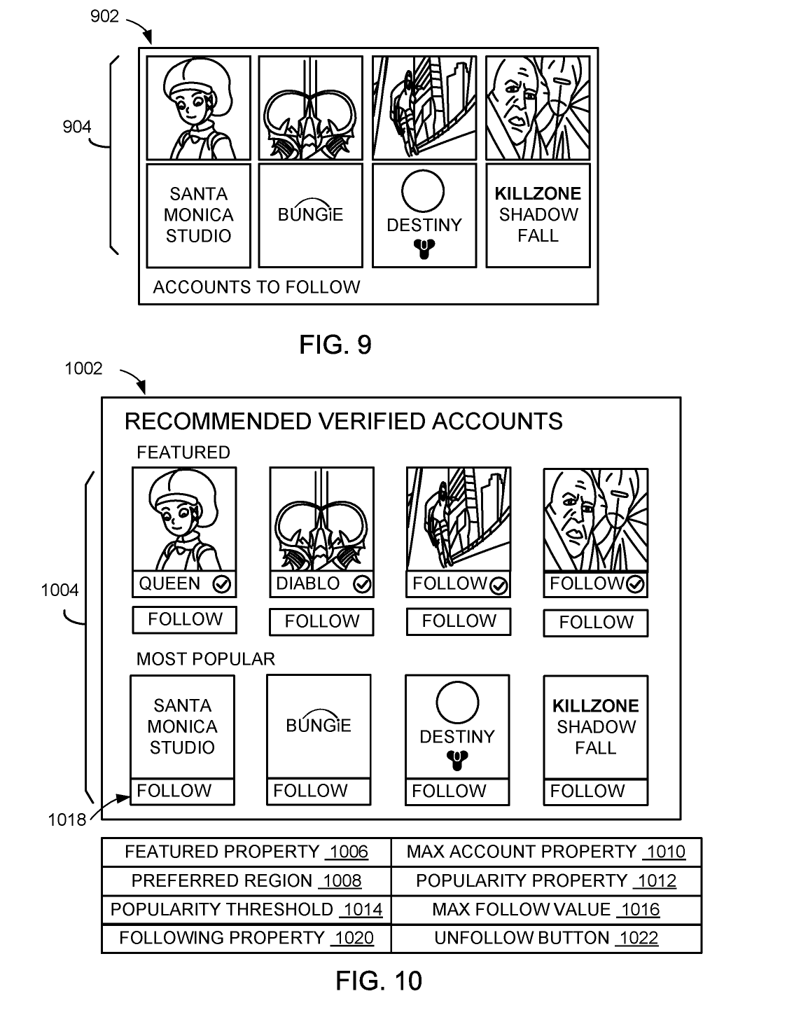

Referring now to FIG. 9, therein is shown an example of a whats new information tile screen 902. The whats new information tile screen 902 can display recommendation information about one the verified accounts 206 of FIG. 2.

The whats new information tile screen 902 is a user screen for interacting with users. The whats new information tile screen 902 can be accessed via the electronic processing system 100 of FIG. 1.

The whats new information tile screen 902 is a tiled window providing a graphical display of recommended accounts to follow. The whats new information tile screen 902 can include account icons 904 of a list of the verified accounts 206 that can be followed. Clicking or selecting one of the account icons 904 can take the user to detailed screen for more information. In another example, clicking on one of the account icons 904 can initiate following.

The content of the whats new information tile screen 902 can include the verified accounts 206 linked by interested players, popular content, content with recent changes, content that matches a user profile, or a combination thereof. Alternatively, the whats new information tile screen 902 can display the account icons using a random distribution, an alphabetical distribution, a numeric distribution, a time distribution, a regional distribution, or a combination thereof.

It has been discovered that displaying the whats new information tile screen 902 simplifies following. Presenting new examples of the verified accounts 206 makes it easier for the user to find interesting content.

Referring now to FIG. 10, therein is shown an example of a recommended verified accounts screen 1002. The recommended verified accounts screen 1002 can display a set of recommendations for the verified accounts 206 of FIG. 2 for the user.

The recommended verified accounts screen 1002 is a user screen for interacting with users. The recommended verified accounts screen 1002 can be accessed via the electronic processing system 100 of FIG. 1.

The recommended verified accounts screen 1002 can have a variety of configurations. The recommended verified accounts screen 1002 can display a set of the account icons 904 of FIG. 9 that selected for the users based on a variety of selection criteria. Each of the account icons 904 can include a following button 1018 used to follow one of the verified accounts 206 associated with both the account icons 904 and the following button 1018.

The following button 1018 can allow the user to follow the currently selected one of the verified accounts 206. The following button 1018 can set the value of a following property 1020 associated with one of the verified accounts 206. The following property 1020 can be used to indicate that the user is following one of the verified accounts 206.

Following one of the verified accounts 206 means that status and updates about the selected one of the verified accounts 206 will be available to the user who is following. Following includes becoming one of the followers 216 and having access to special privileges and content related to the selected one of the verified accounts 206.

In an illustrative example, the set of the account icons 904 can be selected based on being featured accounts 1004. One of the verified accounts 206 can be marked as featured by having a featured property 1006. The featured property 1006 can be manually set using an account management tool such as the Zeniba Tool or similar tools for managing the properties associated with the verified accounts 206.

An unfollow button 1022 can also be provided after the following button 1018 has been selected. The unfollow button 1022 allows the user to cancel their following of one of the verified account 206. Clicking the unfollow button 1022 can toggle the state to the following button 1018.

The following process can have a maximum follow value 1016. The maximum follow value 1016 is the maximum number of the verified accounts 206 that a user can follow. However, it is understood that the number of users who can follow one of the verified accounts 206 is not limited and can be any value.

The users can discover the verified accounts 206 in a variety of ways. For example, there can be recommendations on the whats new information tile screen 902 of FIG. 9, friends can follow stories on the whats new information tile screen 902, text searching, and recommendation from the friends application screen 702 of FIG. 7.

The user account 204 of FIG. 2 can have a preferred region 1008. The preferred region 1008 can be used to indicate that one of the verified accounts 206 is only featured in a particular region. The preferred region 1008 can be a single region or a list of multiple regions. The preferred region 1008 can include a rating or preferential value for ranking the regions in the list.

The recommended verified accounts screen 1002 can have a maximum accounts property 1010. The maximum accounts property 1010 can provide an upper limit to the number of the verified accounts 206 to be displayed at one time.

In another example, the set of the account icons 904 can be selected based on a popularity property 1012. A set of popular accounts can be selected where each of the popular accounts have the popularity property 1012 greater than a popularity threshold 1014. The popularity threshold 1014 can be a numerical value.

The popularity property 1012 can be an auto-generated value to indicate how relative popularity of one of the verified accounts 206 based on the number of followers, the number of recently joined followers, the number of followers by region, or a combination thereof. The number of the account icons 904 displayed based on popularity can have an upper limit of 50 for the maximum accounts property 1010. The popular accounts can be refreshed based on the change in the number of the followers 216 of FIG. 2.

The recommended verified accounts screen 1002 can display a combination of the featured accounts 1004 and the popular accounts. The list of popular accounts can be refreshed on an hourly, daily, weekly, monthly, or other time based basis. There can be a maximum number of the popular accounts. For example, the maximum number of popular accounts displayed can be set to 50.

It has been discovered that displaying the recommended verified accounts screen 1002 simplifies following. Presenting the recommendation list 318 of FIG. 3 makes it easier for the user to find interesting content.

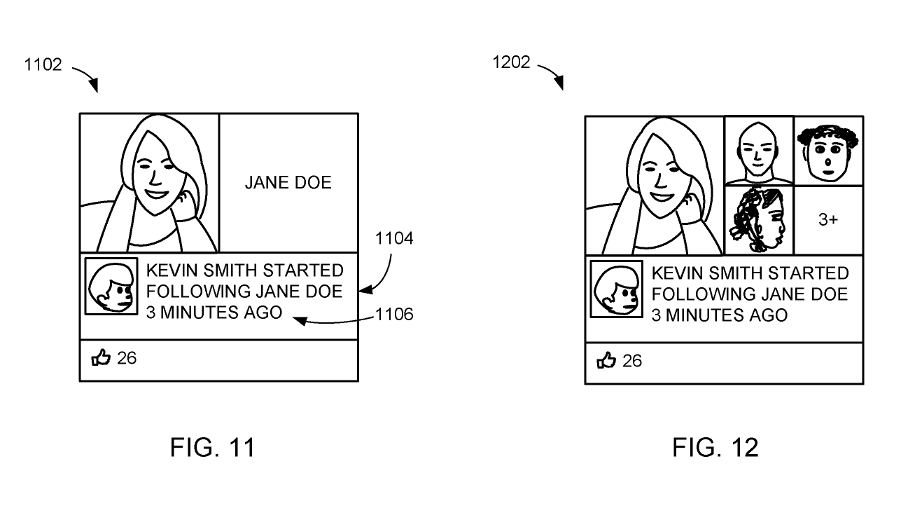

Referring now to FIG. 11, therein is shown an example of a single grid view screen 1102. The single grid view screen 1102 can display information for a user following one of the verified accounts 206 of FIG. 2.

The single grid view screen 1102 is a user screen for interacting with users. The single grid view screen 1102 can be accessed via the electronic processing system 100 of FIG. 1.

The single grid view screen 1102 can have a variety of configurations. The single grid view screen 1102 can include the user identification 504 of FIG. 5, the verified image 506 of FIG. 5, a grid screen text 1104, and the following status 310 of FIG. 3.

The user identification 504 can provide a link to one of the verified accounts 206. The user identification 504 can include a visual indicator, such as an icon, to identify the user.

The verified image 506 is a context specific image. The verified image 506 can be a logo, image, picture, graphic, or a combination thereof.

The grid screen text 1104 is a text message. The grid screen text 1104 can be a descriptive message about one of the verified accounts 206.

The grid screen status 1106 is a status indicator. For example, the tile status 510 of FIG. 10 can indicate the time since the last update.

The following status 310 can provide information about the status of one of the verified accounts 206 being followed. The following status 310 can be used to display an icon to show the following status 310.

It has been discovered that displaying the single grid view screen 1102 simplifies following one of the verified accounts 206. Presenting the status information to the user makes it easier for the user to find interesting content.

Referring now to FIG. 12, therein is shown an example of a multiple grid view screen 1202. The multiple grid view screen 1202 can display information for multiple friends of the user following one of the verified accounts 206 of FIG. 2.

The multiple grid view screen 1202 is a user screen for interacting with users. The multiple grid view screen 1202 can be accessed via the electronic processing system 100 of FIG. 1.

The multiple grid view screen 1202 can have a variety of configurations. The single grid view screen 1102 can include the user identification 504 of FIG. 5, the verified image 506 of FIG. 5, the grid screen text 1104, and the following status 310 of FIG. 3.

The user identification 504 can provide a link to one of the verified accounts 206. The user identification 504 can include a visual indicator, such as an icon, to identify the user.

The verified image 506 is a context specific image. The verified image 506 can be a logo, image, picture, graphic, or a combination thereof.

The grid screen text 1104 is a text message. The grid screen text 1104 can be a descriptive message about one of the verified accounts 206. For example, the grid screen text 1104 can display information about the number of friends that are following one of the verified accounts 206.

The grid screen status 1106 is a status indicator. For example, the tile status 510 can indicate the time since the last update.

It has been discovered that displaying the multiple grid view screen 1202 simplifies following. Presenting the information to the user about other following users makes it easier for the user to find interesting content.

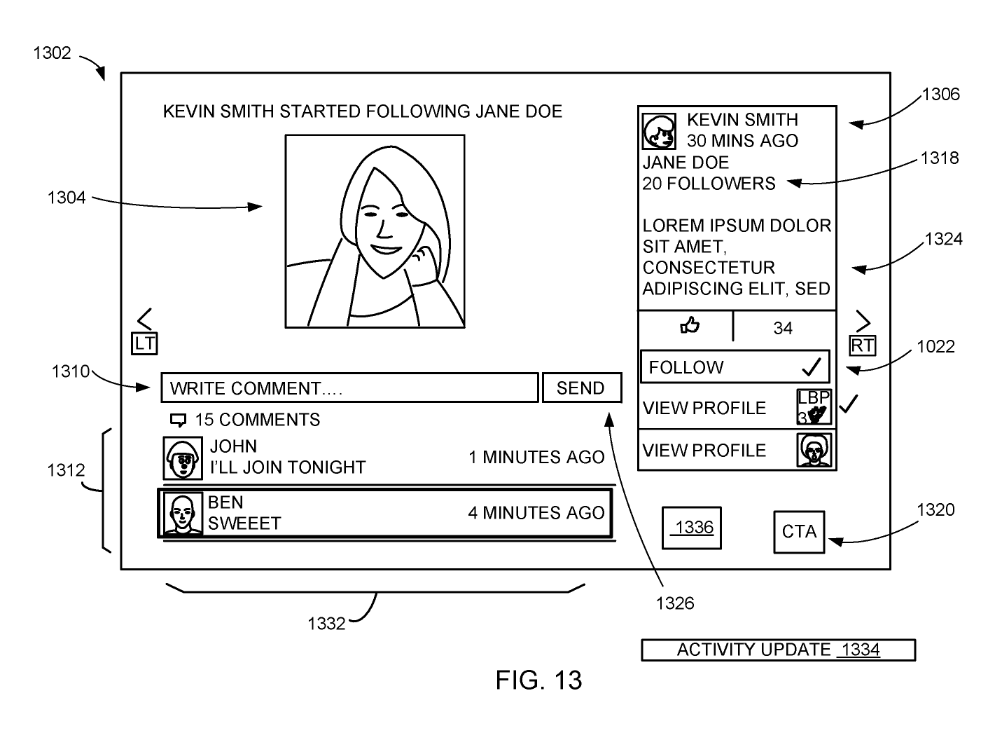

Referring now to FIG. 13, therein is shown an example of a gallery following view 1302. The gallery following view 1302 can display information about one of the verified accounts 206 of FIG. 2.

The gallery following view 1302 is a user screen for interacting with users. The gallery following view 1302 can be accessed via the electronic processing system 100 of FIG. 1.

The gallery following view 1302 can have a variety of configurations. The gallery following view 1302 can include the display name 307, the following count 710 of FIG. 7, a gallery view image 1304, a gallery view status 1306, gallery comments control 1308, a comment entry control 1310, and the following button 1018.

The gallery view image 1304 is an image or video for identifying one of the verified accounts 206. The gallery view status 1306 can provide a descriptive status for one of the verified accounts 206. The gallery comments control 1308 provides a list of comments 1312 entered from users. The list of comments 1312 can be presented in a comments list display 1332.

The comments list display 1332 can display the list of comments 1312 based on an activity update 1334. The activity update 1334 is an action taken by the user. For example, if the user associated with one of the verified accounts 206 is taking part in a tournament, then the activity update 1334 for playing in the tournament can be issued. The list of comments 1312 displayed in the comments list display 1332 can show that the user is in the tournament by display a new one of the comments 1312.

In an illustrative example, the user can discover new experiences from other interested players by following one of the verified accounts 206. The user can receive and interact with the activity update 1334. This provides easy access and new ways to share content with others within the gaming network 104 of FIG. 1. It also encourages users to share with other users of the gaming network 104. Providing information on the number of the followers 216 of FIG. 2 for a particular one of the verified accounts 206 can encourage following the verified accounts 206. In addition, the verified accounts 206 can advertise directly to users who are interested in them. This can be done by matching profile information or comparing other usage by the user.

The comment entry control 1310 allows the entry of the comments 1312 by users. The users can enter the text of the comments 1312 and click a comment send button 1326 to save the comments 1312 associated with one of the verified accounts 206. The new comment can then be displayed in a gallery comment control 1324. The gallery comment control 1324 is a control for displaying the comments 1312.

The following button 1018 can allow the user to follow the currently selected one of the verified accounts 206. The following button 1018 can set the value of the following property 1020 associated with one of the verified accounts 206.

When one of the users starts following one of the verified accounts 206, following activity 1318 can be posted as one of the comments 1312 associated with one of the verified accounts 206. For example, one of the comments 1312 can be a “started following” message. The following activity 1318 can indicate that following has started or stopped.

The gallery following view 1302 can include a Call-To-Action (CTA) button 1320 to start following one of the verified accounts 206. In addition, the profile screen 802 of FIG. 8 can include the CTA button 1320 to go to the profile screen 802 of one of the selected accounts.

The gallery comments control 1308 can optimize the display of the comments 1312 in a variety of ways. The gallery comments control 1308 can combine multiple similar ones of the comments 1312 into a single entry. For example, the gallery comments control 1308 can combine N new follower comments into a single one of the comments 1312. Optimization includes reducing the amount of screen real estate required to display comments by condensing the comments 1312.

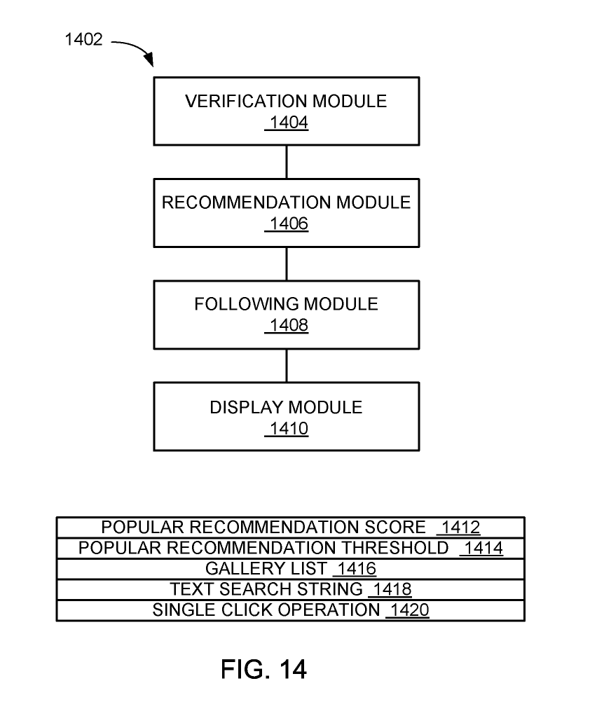

Referring now to FIG. 14, therein is shown an exemplary process flow of a follow verified accounts process 1402. The follow verified accounts process 1402 describes the actions for following one of the verified accounts 206 of FIG. 2.

The follow verified accounts process 1402 can create one of the verified accounts 206 and allow the user account 204 of FIG. 2 to follow the selected one of the verified accounts. The follow verified accounts process 1402 can include a verification module 1404, a recommendation module 1406, a following module 1408, and a display module 1410.

In the verification module 1404, the process flow can create one of the verified accounts 206 by validating one of the verified accounts 206 with the known good list 212 of FIG. 2. The known good list 212 is a list of the verified accounts 206 that have been pre-authorized to represent the specific people, games, gaming companies, gaming franchisees, content objects, or a combination thereof.

The known good list 212 can be created by the operator of the gaming network 104. The operator of the gaming network 104 of FIG. 1 can be responsible for managing the user account 204 for the gaming network 104. After the verification module 1404 has completed, the control flow can pass to the recommendation module 1406.

In the recommendation module 1406, the recommendation list 318 of FIG. 3 of the verified accounts 206 can be presented to the user. Once the recommendation list 318 has been presented to the user, the user can select one of the verified accounts 206.

The recommendation list 318 can be formed in a variety of ways. For example, the user can enter a text search string 1418 and receive the recommendation list 318 based on the search string. The search can cover all of the verified accounts 206 in the system.

In another example, the recommendation list 318 can be retrieved based on the preferred region 1008 associated with the user account 204. This would allow the recommendation list 318 to be populated with the verified accounts 206 of people, games, and media in the preferred region 1008.

In yet another example, the recommendation list 318 can be retrieved based on a popular recommendation score 1412 of the verified accounts 206 being greater than a popular recommendation threshold 1414. The popular recommendation threshold 1414 can be a numeric value. The popular recommendation score 1412 of the verified accounts 206 can be calculated based on the number of users following the account, direct scoring by user surveys, the number of accesses to content of the verified accounts 206, or a combination thereof.

In still another example, the recommendation list 318 can be based on the verified accounts 206 that are already being following by users in the friends list 314 of FIG. 3. This can allow the retrieval of the verified accounts 206 based on the common interests of friends in the friends list 314 associated with the user account 204.

Once the recommendation list 318 has been retrieved and populated, the recommendation list 318 can be displayed for the user to select one of the verified accounts 206. For example, the recommendation list 318 can be displayed on the profile screen 802 of FIG. 8 or a gallery list 1416. Each of the entries in the recommendation list 318 can have the following button 1018 associated with it. After the recommendation module 1406 has completed, the control flow can pass to the following module 1408.

In another example, the recommendation list 318 can include a single one of the verified accounts 206. In this case, the recommendation list 318 can be displayed as a single entry, for example on the profile screen 802. The profile screen 802 can include the following button 1018.

In the following module 1408, the user can select one of the verified accounts 206 to follow by making a single click operation 1420 on the following button 1018 one of the verified accounts 206 in the recommendation list 318 that is being displayed. The single click operation 1420 is simple operation where the following button 1018 is clicked once to execute the following of one of the verified accounts 206.

For example, on the profile screen 802, the user can follow one of the verified accounts 206 by performing the single click operation 1420 on the following button 1018. The single click operation 1420 requires only a single click on the following button 1018 to initiate the following operation. The single click operation 1420 does not require any further confirmation from the system or from a third party.

In another example, the recommendation list 318 can include the following button 1018 associated with each of the verified accounts 206 as shown in the gallery view 602 of FIG. 6. The user can follow one of the verified accounts 206 by clicking the following button 1018 adjacent in the gallery view.

The single click operation 1420 requires only a single click on the following button 1018 to initiate the following operation. The single click operation 1420 does not require any further confirmation from the system or from a third party. Once the following button 1018 is displayed, the single click operation 1420 will cause the selected one of the verified accounts 206 to be followed with any further action. Once the following module 1408 has completed, the control flow can pass to the display module 1410.

The users can follow the verified accounts 206 associated with the people, VIPs, community managers, games, game franchises who share interests in related content. Using the single click operation 1420 to follow one of the verified accounts 206 provides a simplified way to connect with the content of the verified accounts 206. Once one of the verified accounts 206 is being followed, a following icon can be used to identify the specific one of the verified accounts 206 that is being followed.

In the display module 1410, the electronic processing system 100 of FIG. 1 can display the results of the following operation. The system can update the profile screen 802 or the gallery view 602 to show that the following button 1018 has been clicked. This can be performed by displaying a check mark within the following button 1018. After completion, the control flow can terminate.

It has been discovered that providing the single click operation 1420 to follow one of the verified accounts 206 simplifies the operation of the electronic processing system 100. By reducing the effort required to follow one of the verified accounts 206, the user saves time and increases the likelihood of discovering additional interesting ones of the verified accounts 206.

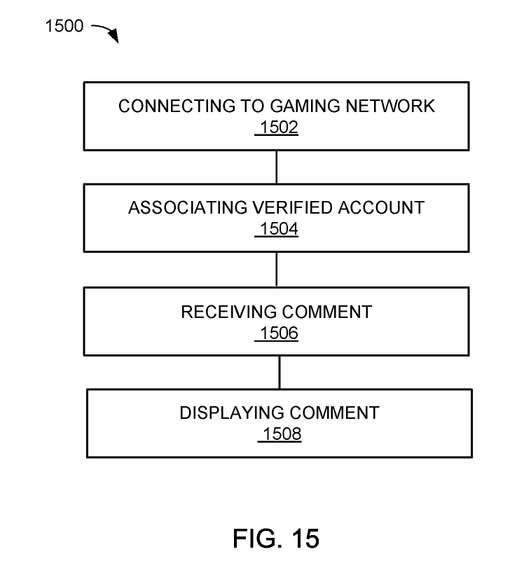

Referring now to FIG. 15, therein is shown a flow chart of a method 1500 of operation of an electronic processing system in a further embodiment of the present invention. The method 1500 includes connecting to a gaming network using a user account in a block 1502; associating a verified account with the user account by performing a single click operation on a following button to follow the verified account in a block 1504; receiving a comment about the verified account in a comment entry control in a block 1506; and displaying the comment in a comments list display in a block 1508.

Thus, it has been discovered that the electronic processing system 100 of FIG. 1 of the embodiments of the present invention furnish important and heretofore unknown and unavailable solutions, capabilities, and functional aspects for the electronic processing system 100 with the social network mechanism. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the embodiments of the present invention is that it valuably supports and services the historical trend of reducing costs, simplifying systems, and increasing performance.

These and other valuable aspects of the embodiments of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of an electronic processing system comprising:
connecting to a gaming network using a user account;
associating a verified account with the user account by performing a single click operation on a following button to follow the verified account;
receiving a comment about the verified account in a comment entry control; and
displaying the comment in a comments list display.

2. The method as claimed in claim 1 wherein associating the verified account with the user account includes validating the user account against a known good list.

3. The method as claimed in claim 1 further comprising
receiving an activity update based on the verified account; and
displaying the activity update in the comments list display.

4. The method as claimed in claim 1 further comprising displaying the verified account having a verified region within a preferred region associated with the user account.

5. The method as claimed in claim 1 further comprising forming a recommendation list having a recommended verified account with a verified region in a preferred region associated with the user account.

6. A method of operation of an electronic processing system comprising:
connecting to a gaming network using a user account to establish a network connection to the gaming network;
associating a verified account with the user account by performing a single click operation on a following button in a recommendation list to follow the verified account;
receiving a comment about the verified account in a comment entry control; and
displaying the comment in a comments list display.

7. The method as claimed in claim 6 further comprising receiving the recommendation list having another verified account based on a text search string.

8. The method as claimed in claim 6 wherein unfollowing the verified account includes unfollowing the verified account by single clicking on an unfollowing button.

9. The method as claimed in claim 6 wherein the verified account represents a person, company, gaming entity, media item, executive, or game.

10. The method as claimed in claim 6 further comprising displaying a verified icon on a profile screen for the verified account.

11. An electronic processing system comprising:
a verification module for connecting to a gaming network using a user account and for associating a verified account with the user account by performing a single click operation on a following button to follow the verified account;
a recommendation module, coupled to the verification module, for receiving a comment about the verified account in a comment entry control; and
a display module, coupled to the recommendation module, for displaying the comment in a comments list display.

12. The system as claimed in claim 11 wherein the verification module includes validating the user account against a known good list.

13. The system as claimed in claim 11 wherein the recommendation module is for receiving an activity update based on the verified account; and the display module is for displaying the activity update in the comments list display.

14. The system as claimed in claim 11 wherein the display module is for displaying the verified account having a verified region within a preferred region associated with the user account.

15. The system as claimed in claim 11 wherein the recommendation module is for forming a recommendation list having a recommended verified account with a verified region in a preferred region associated with the user account.

16. The system as claimed in claim 11 wherein the verification module includes the following button in a recommendation list.

17. The system as claimed in claim 16 wherein the recommendation module is for receiving the recommendation list having another verified account based on a text search string.

18. The system as claimed in claim 16 wherein the following module is for unfollowing the verified account using single click operation on an unfollowing button.

19. The system as claimed in claim 16 wherein the verified account represents a person, company, gaming entity, media item, executive, or game.

20. The system as claimed in claim 16 wherein the display module is for displaying a verified icon on a profile screen for the verified account.
